(19) United States
(12) Patent Application Publication
(10) Pub. No.: US 2019/0153998 A1
(43) Pub. Date: May 23, 2019

(54) VERTICAL AXIS WIND TURBINE WITH MOVING BLADES

(71) Applicant: Flaminio FRACAROLI, Montecchio Maggiore (IT)

(72) Inventor: Flaminio FRACAROLI, Montecchio Maggiore (IT)

(21) Appl. No.: 16/098,393

(22) PCT Filed: May 2, 2017
(86) PCT No.: PCT/IT2017/000097

§ 371 Date: Nov. 1, 2018

(30) Foreign Application Priority Data
May 4, 2016 (IT) 102016000045547

(51) Int. Cl. F03D 3/06; F03D 7/06; F03D 3/00

(52) U.S. Cl. CPC F03D 3/068; F03D 7/06; F03D 3/005; F03D 3/064; F05B 2270/32; F05B 2260/72; F05B 2260/90; F05B 2260/76; F05B 2270/101; F05B 2240/212

(57) ABSTRACT

This invention specifically refers to a vertical axis wind turbine of the Darrieus type. More specifically, this invention refers to a vertical axis wind turbine of the Darrieus type fitted with moving vertical blades, for power generation.

This invention, from a technical viewpoint, falls within the scope of wind generators. This invention specifically refers to a vertical axis wind turbine of the Darrieus type. More specifically, this invention refers to a vertical axis wind turbine of the Darrieus type fitted with moving vertical blades, for power generation.

### STATE OF THE ART

In the power generation industry, devices consisting of vertical axis wind turbines (VAWT), also known as Darrieus type, have been in use for some time. This type of turbine basically consists of three or more blades, positioned in a vertical direction, parallel to the turbine rotor vertical axis, placed peripherally in respect of the said axis, at a certain distance (radius), equally distant one from the other, firmly connected to the metal arms which support them and connect them to the central rotor of the turbine under examination.— Initially the blades were linear, then other patents introduced many other shapes, of several curved types; in some cases the blades are not fixed but moving. The Darrieus vertical axis blades operate by carrying capacity, with winds coming from any direction. However, state-of-the-art Darrieus turbines, either with fixed or moving blades, seem to have some technical shortcomings. The first shortcoming of these turbines is their difficulty in starting the turbine rotor movement, that is to say the difficulty in breaking inertia, especially with low wind speeds.— This is a typical shortcoming in turbines of the known type as operating by carrying capacity.—

Sometimes the solution used in order to eliminate this shortcoming for Darrieus type turbines is a coupling with blades operating by resistance to the wind or other known systems. Another shortcoming in these turbines is that they do not have any self-limitation system with strong winds, which means that there can be mechanical hold and efficiency issues as regards power generation.

The purpose of this invention is to resolve the aforesaid shortcomings.

Moreover, another purpose of this invention is to present a solution which allows for an increase in performance of the turbine as a whole, both with average and high wind speeds. The term “performance” refers to a higher torque of the rotor in the turbine referred to in this patent, compared to the torques of other types of turbines, with the same wind speed, the same blade surface areas and air surface affected by the movement of the latter. Another purpose of this invention consists in designing a system which can easily stop turbine rotation if the winds are particularly strong.

### SUMMARY OF THIS INVENTION

This invention involves the construction of a vertical axis wind turbine consisting of a rotor with three or more moving blades, placed peripherally in respect of the turbine rotor, equidistant from the turbine axis, individually connected to the said rotor through one or more first connection devices; on the rotor side the latter are fitted with joints, and on the blade side with hinges. This allows each blade to revolve around its vertical axis, taking different angular positions in respect of the relevant connection devices; these angular positions are achieved by means of auxiliary control devices operated by a suitable piloting mechanism associated with the movement of the central rotor. The purpose of this invention, therefore, consists in the construction of a vertical axis wind turbine which shall include a rotor that can only revolve around its vertical support structure; the latter is of varying length and firmly connected to the ground (pillar, trellis, loft, roof, etc.).

The height of the rotor is based on its vertical rotation axis, which is the same as that of the turbine, with a length sufficient for the correct and safe fixing of all connection devices on the three or more blades which, as already mentioned, are placed vertically, following a peripheral direction in respect of the rotor in question, equidistant from the turbine rotation axis.— The vertical length of the rotor shall also include the fixing points for any tie-rods and bracing mechanisms for the mechanical strengthening of the revolving structure, as well as any devices for transmitting its revolving motion to the power generator. Each blade is connected with the relevant first connection mechanisms through a hinge; on the opposite side, the first connection mechanisms are firmly fixed to the rotor by means of joints.— The said connection mechanisms allow the three or more blades of the rotor to revolve at the same time, following the main rotation axis of the turbine. At the same time, the blades are free to move following their vertical axis because they are controlled by suitable mechanisms. The various angular positions of the blades with regard to their own axis during the revolving movement around the turbine axis—as already mentioned—are achieved by means of auxiliary control mechanisms associated with each blade; the latter include control mechanisms with one end fixed onto the said blades using a hinge at a predetermined distance from the rotation axis of each blade, and the other end connected—also using a hinge—to the first connection mechanisms which belongs to the piloting device shared by all the blades in the turbine, located in the centre of the said turbine rotor.— This piloting device is mechanically operated and moves all its connection elements at the same time, their number being the same as the number of blades, while the rotor is in motion, with different speeds and angles; as a consequence the entry side of the wing profile of the blades will have the most favourable incidence angle in respect of the wind, which is expected to produce the highest possible torque in the turbine. According to a preferred implementation form of this invention, the piloting device shall include a control pivot whose axis runs parallel to the main rotation axis of the turbine, as well as a number of first and second connection elements which coincides with the number of blades.— This control pivot can follow a linear movement, in a horizontal direction, operated by an electric motor.— The length of its horizontal freedom of movement is predefined.— The axis of the control pivot which causes it to move coincides with the axis of the turbine.— The control pivot includes all the hinges on the end of the first connecting elements of all blades in order to connect the latter (control pivot) with the various control elements of the individual blades, as mentioned above, always using hinge mechanisms.— The second group of connecting elements, with hinge mechanisms on all ends, and parallel axis one with the other, connect the fixed pivots located in the centreline of all first connecting elements with the fixed pivots placed, for each blade, in axis to one of the connection mechanisms, with the distance from the turbine axis being equal to the length of the said second connecting elements.— More specifically, this value is expected to be half of the length of the first connecting elements. The horizontal linear movement of the control pivot mentioned above, which produces all the various angular movements of the blades while the rotor revolves, is produced by an electric motor as a consequence of the enabling of its shaft by a control unit, after the latter has finished processing the data related to current wind speed, which is measured by an anemometer installed for this purpose close to the turbine. The vertical control pivot will move further apart from the turbine axis proportionally to the wind speed measured at that moment becoming weaker. The distance of the control pivot axis from the turbine axis will be inversely proportional to the wind speed which is measured at that moment. According to a preferred implementation form of this invention, the control pivot can also be placed in a position which coincides with the main rotation axis where the distance of the control pivot axis compared to the main turbine rotation axis equals zero. In this case the blades remain in the same angular position (90°) as the first connecting mechanisms while the blades are revolving around the rotor, that is to say during the whole turbine rotation. A second electric motor is assembled and supported inside the mechanical support of the whole turbine, in axis with the rotor of the latter, therefore with an axis which coincides with the main one of the turbine. The shaft of the aforesaid motor is connected, by means of a mechanical joint and of a self-centering element, to the turbine support, sustained by the horizontally sliding cart onto which the vertical control pivot referred to above when describing the piloting device is firmly fixed.— if necessary it is possible to install a suitable speed reducer between the electric motor and the mechanical joint.— The control unit, after having recorded and analysed the angular value of the wind direction at that moment, by means of a sensor (weathervane), suitably installed close to the turbine, enables the rotation of the shaft on the aforesaid vertical electric motor, with the correct number of rounds to the right or to the left and correctly places the positioning device on the control pivot in the piloting unit, as described above and connected to it, depending on the wind direction at that moment.—

The wind turbine, through the movement of its rotor, starts the revolving movement of the shaft on a power generator.—

### BRIEF DESCRIPTION OF THE ILLUSTRATIONS

The other benefits, objectives and aspects, as well as the implementation forms of this invention, are described in the claims and will be clarified in the sections below by means of the following description, where reference is made to the drawings appended hereto. More specifically:

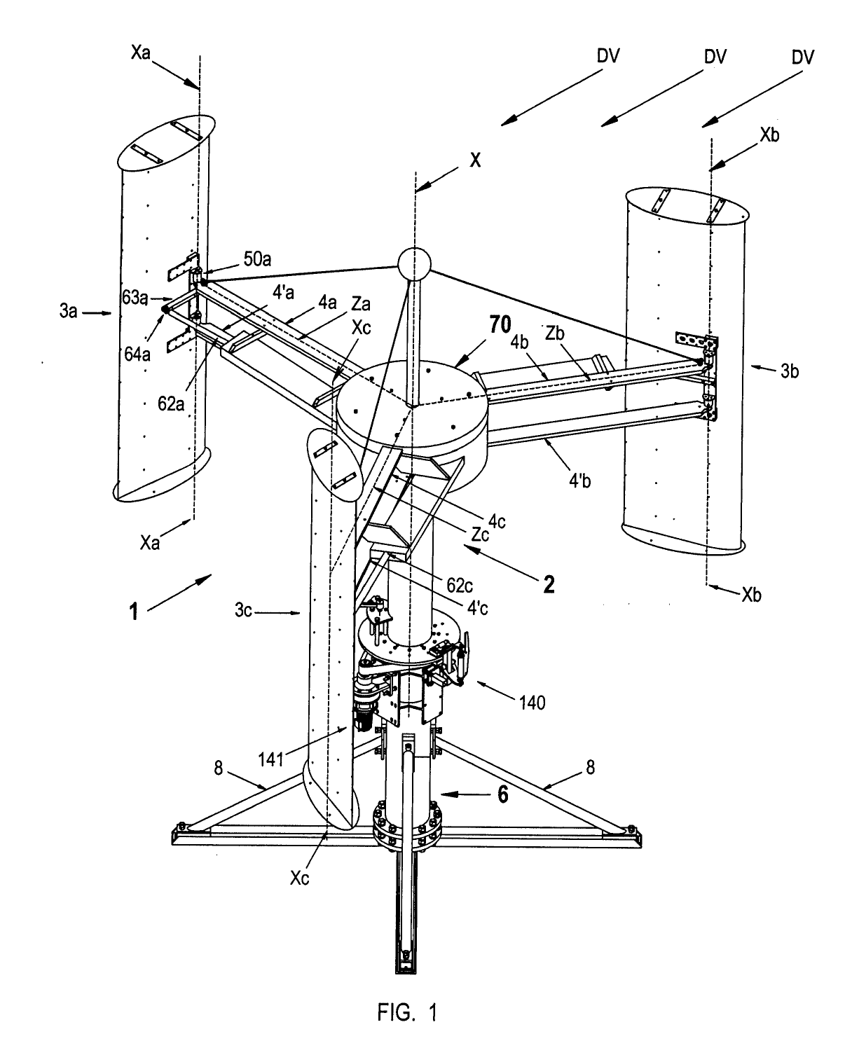

FIG. 1 shows an axonometric view of a preferred implementation form of the wind turbine in this invention;

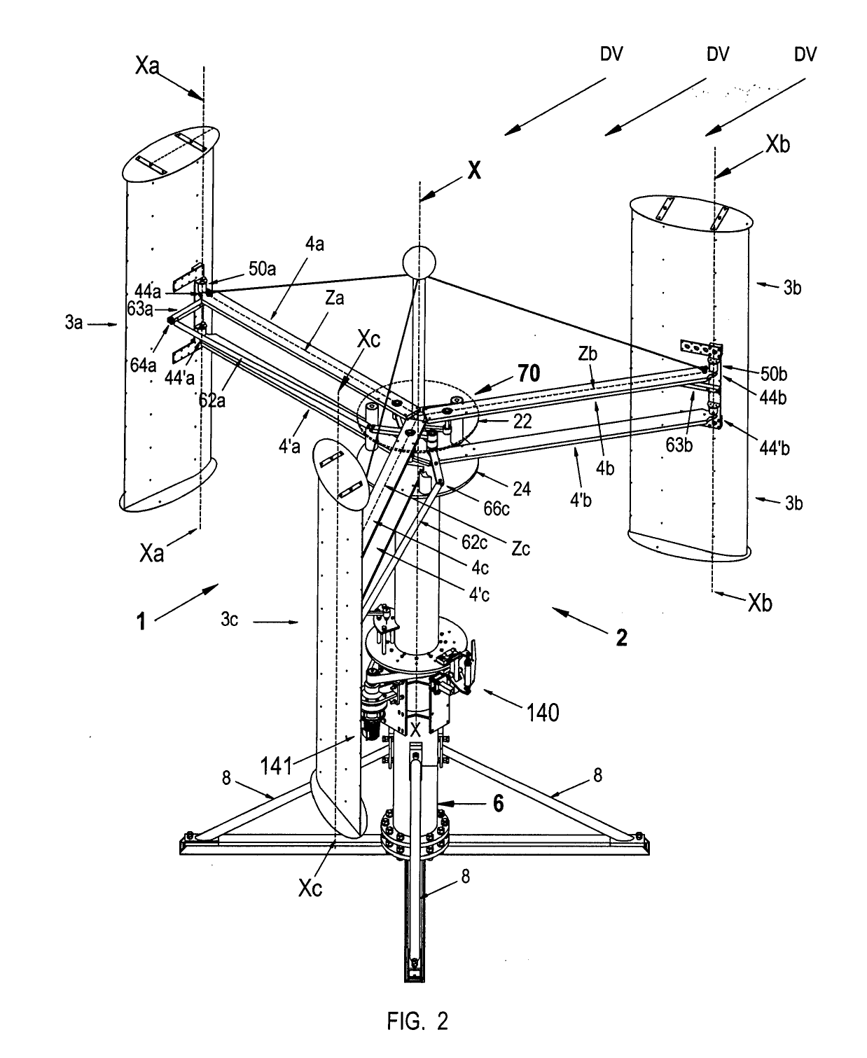

FIG. 2 shows the turbine in FIG. 1 without protection devices;

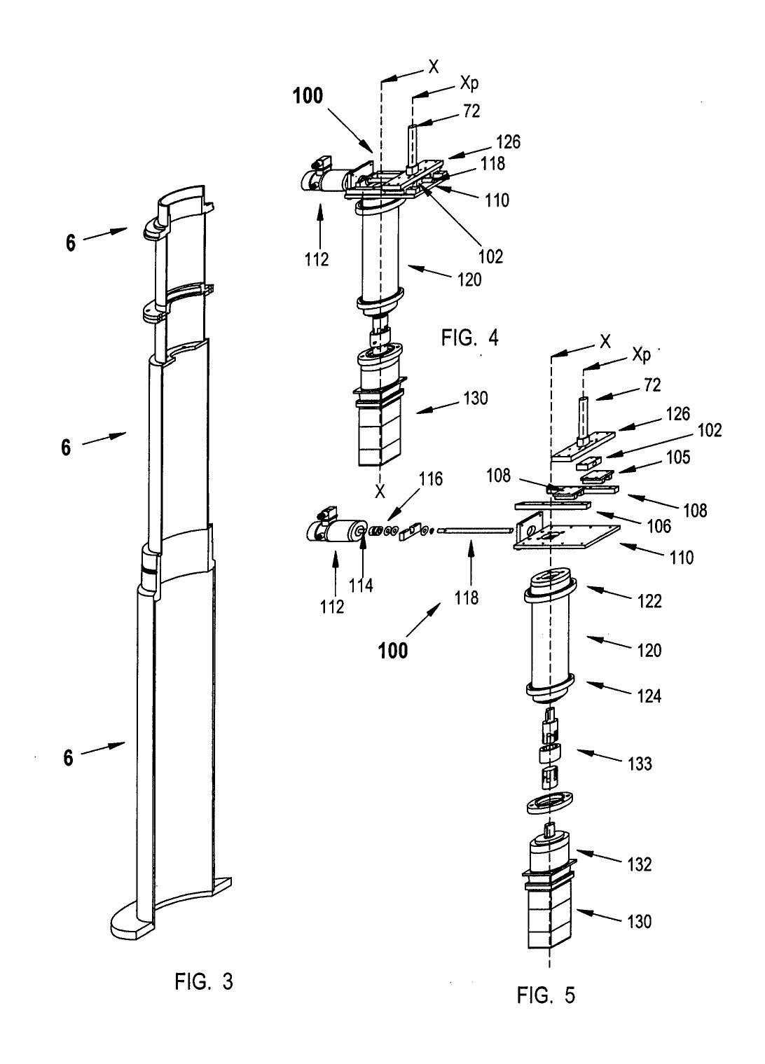

FIG. 3 shows an axonometric view of the vertical section of the support structure (6) on the turbine.—

FIG. 4 shows the motor-driven positioning device (100) of the control pivot (72) fixed onto the self-centring element below (120) allowing for rotation of the system (100) according to the wind direction, using an electric motor (130);

FIG. 5 shows an exploded view of FIG. 4;

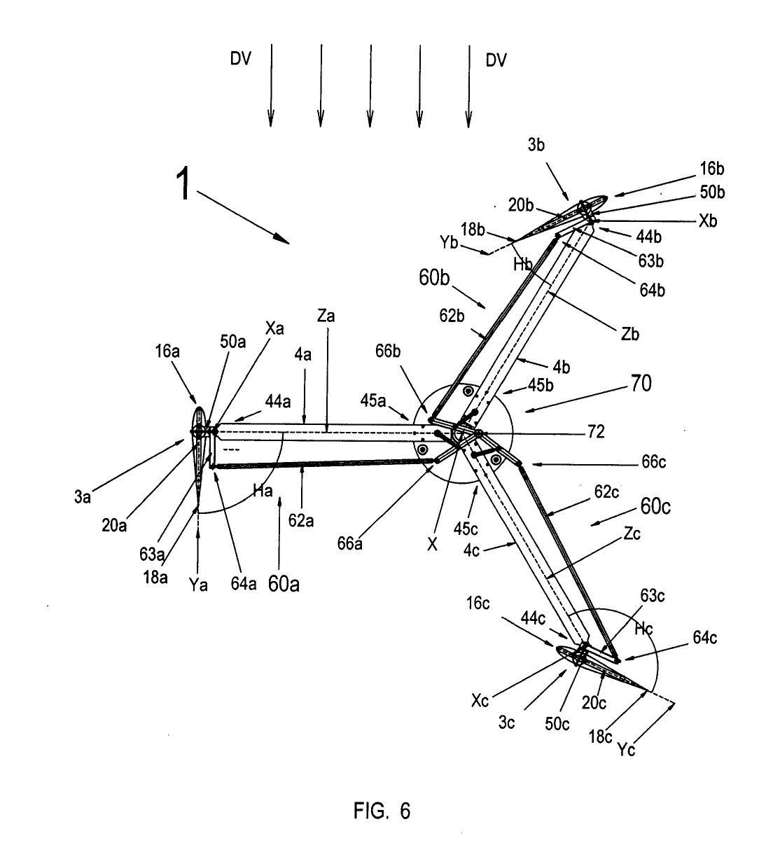

FIG. 6 shows a simplified plane view of FIG. 1 with some elements removed;

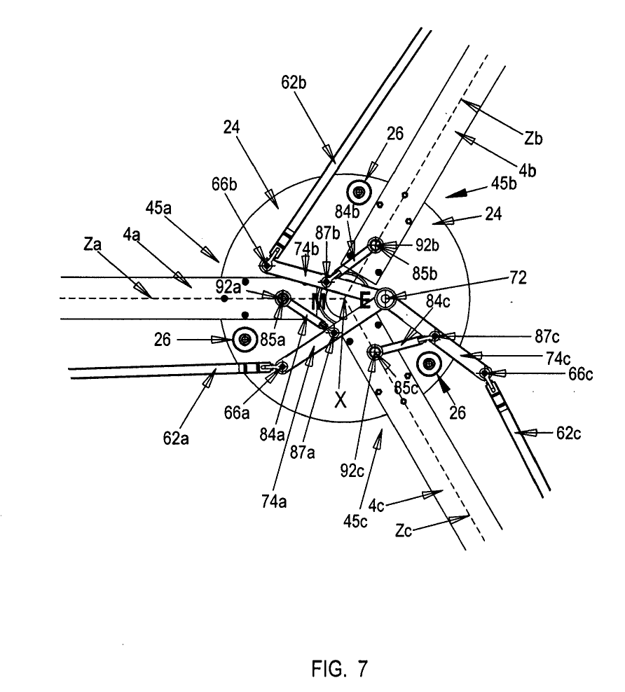

FIG. 7 is an enlargement of a detail taken from the central area in FIG. 6;

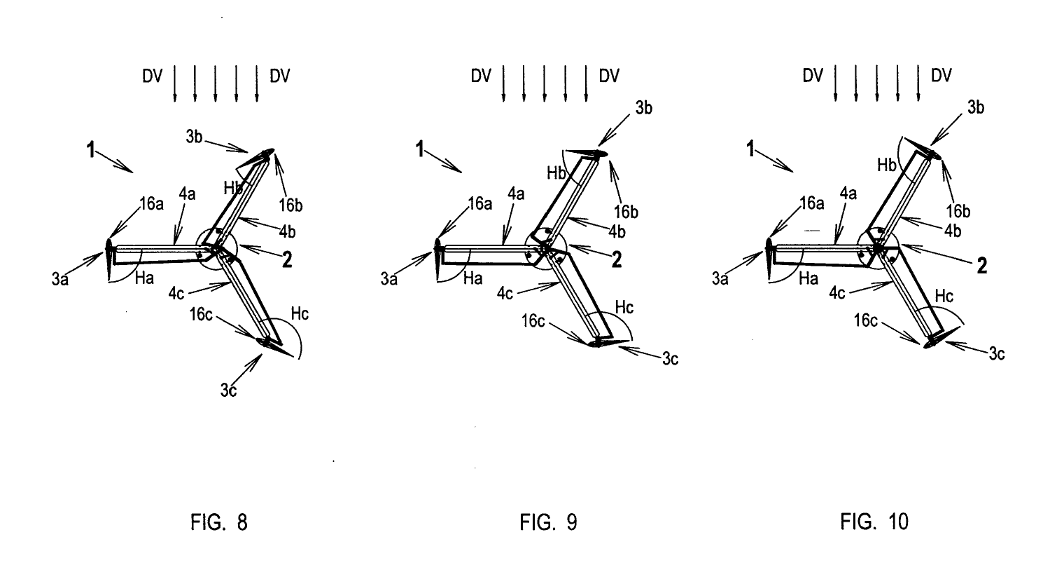

the figures from 8 to 10 include a schematic overview from above of the turbine in FIG. 1, comparing the turbine in various operating positions and where FIG. 8 corresponds to the operating position in FIG. 6;

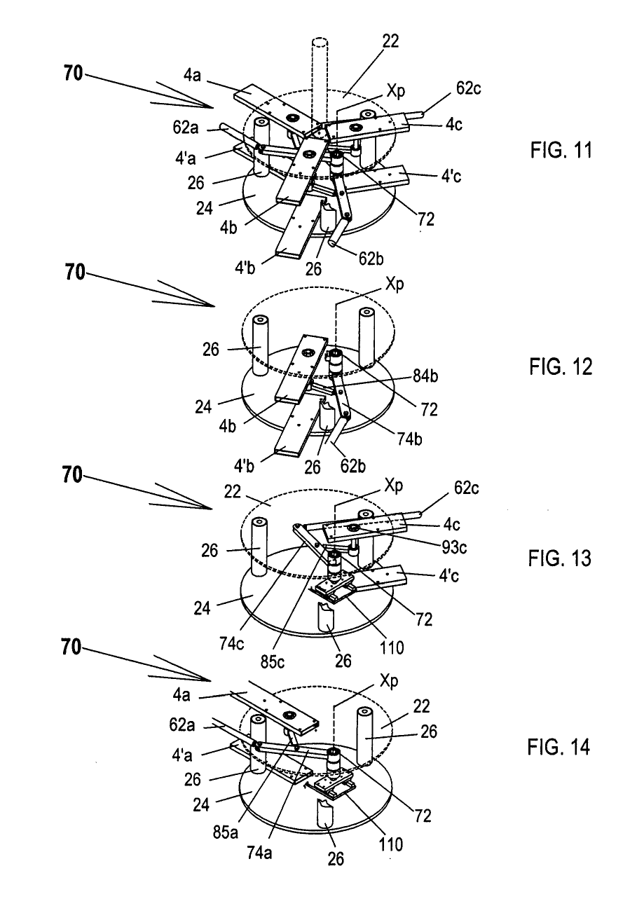

FIG. 11 shows an axonometric view of an enlarged detail from FIG. 2: driving unit (70) for the three blades;

the figures from 12 to 14 show the driving unit for each individual blade;

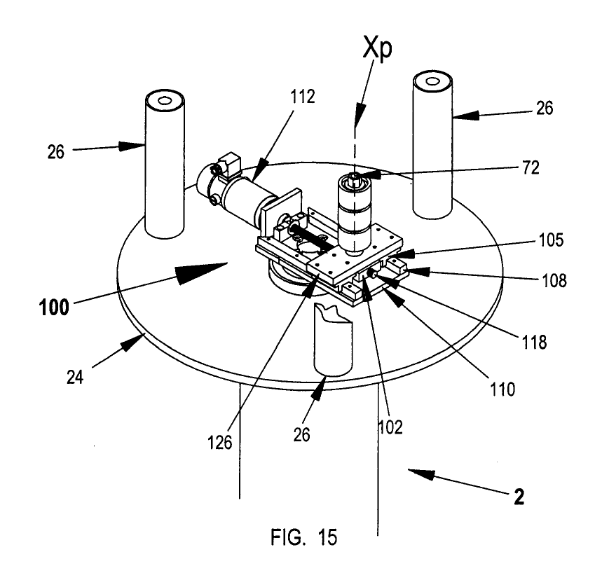

FIG. 15 shows an enlarged detail from FIG. 4 of the motor-driven positioning device (100) on the control pivot (72).— the round supporting element (24) hides the self-centring element (120) to which the device (100) is fixed;

the sequence in FIG. 16 shows a view from above of the turbine in FIG. 1 in various positions during its rotation (specifically every 30°) and corresponding to the initial operating position in 8 (with maximum eccentricity of the control pivot);

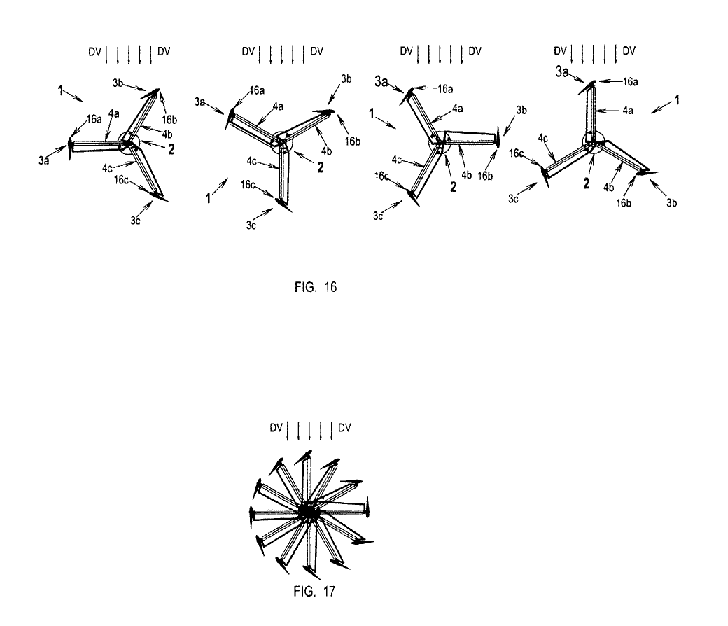

FIG. 17 shows a view from above of the turbine in FIG. 1 with images overlapped of the sequence in FIG. 16 in various positions during rotation (specifically every 30°), corresponding to the initial operating position in FIG. 8 and with maximum eccentricity.—

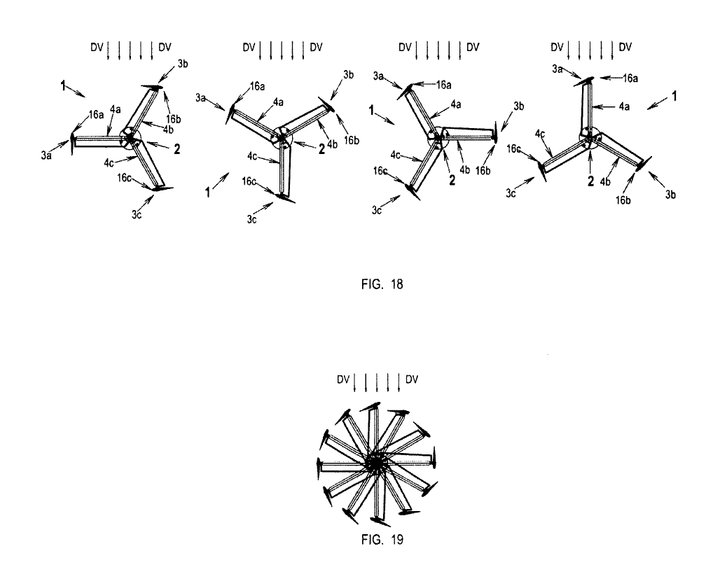

the sequence in FIG. 18 shows a view from above of the turbine in FIG. 1 in various positions during rotation (specifically every 30°) and corresponding to the initial position in FIG. 9 (with medium eccentricity of the control pivot);

FIG. 19 shows a view from above of the turbine in FIG. 1 with images overlapped of the sequence in FIG. 18 in various positions during rotation (specifically every 30°) and with medium eccentricity.—

### DETAILED DESCRIPTION OF THIS INVENTION

This invention is described in the following sections with regard to its implementation form shown in the drawing tables, nevertheless it is not limited merely to the implementation form described in the following sections and shown in the tables below.— In actual fact, the implementation from described and drafted helps clarify some features pertaining to this invention, whose purpose is explained in the relevant claims. This invention has proved to be especially useful with regard to the construction of a vertical axis wind turbine with moving blades which have a symmetric wing profile. It should be noted, however, that this invention can be usefully applied also in the case of vertical axis wind turbines with moving blades, which are all the same although they might differ in terms of number, profile and size. Some of the parts of turbine 1, most notably the blades, are built with practically the same features; therefore in the drawings the similar parts will be referred to using the same number and diversified only through “a”, “b” and “c” following the number. In the following description, for reasons of simplicity, reference will be made only to the parts referred to as “a”, bearing in mind that the description applies to the other similar parts referred to as “b” or “c”. An example of preferred implementation of turbine 1, which is the subject of this invention, appears in the illustrations appended hereto. FIGS. 1 and 2 show that the turbine consists of a rotor 2 which follows a vertical direction around a main rotation axis X, three blades 3a, 3b, 3c, placed peripherally around the said rotor 2 and connected to it by means of the first connecting mechanisms or elements (rods); the latter should ideally include a couple of support rods 4a, 4′a, 4b, 4′b, 4c, 4′c. The support rods 4a, 4′a, 4b, 4′b, 4c, 4′c correspond to the relevant axes Za, Zb, Zc, as shown by the example in FIG. 6. This implementation form includes a couple of support rods for each blades; it is clear, however, that in other implementation forms the number of support rods for each blade may be increased, or possibly even consist of only one support rod.— Also the length of the rods, in various implementation forms, might differ, but they shall always be the same for all blades. The blades 3a, 3b, 3c are placed at the same distance at a 120° angle one from the other.— The said angle will certainly vary as the number of blades varies. As is well known, in wind turbines the wind action caused the blades 3a, 3b, 3c to rotate following the main axis of the turbine.— There is then a rotation of the central rotor 2 which is connected to a power generator 141.— This generator may be assembled coaxially to the rotor 2 or laterally through a gear, belt, chain transmission or otherwise.—

The central rotor 2 is supported through ball or roller bearings by a fixed tubular structure 6, or inner shaft 6, whose base is supported by a stabilising structure with bracing mechanisms 8, for anchoring to the ground or to the relevant support surface, which may be a loft, roof, metal trellis or reinforced concrete structure, etc.—

The turbine 1 is fixed in such a way as to make sure that the main revolving axis X of the rotor is vertical. The rotor 2 revolves coaxially and externally in respect of the inner support shaft 6 through ball or roller bearings—which are not shown here—placed between the inner shaft 6 and the external rotor 2.—

It should be noted that figures from 3 to 5 are shown using “cavalier” axonometry.— the elements which seem elliptic, however, should be regarded as circular.

The blade 3a is developed along its own axis, vertical and parallel to the main rotation axis X of the turbine. In the implementation form shown here, the connection between the two ends 44a and 44′a of the rods 4a, 4′a and the blade 3a consists of two hinges (50a), whose axis are in line with one another, parallel to the turbine axis, coinciding exactly with the blade rotation axis Xa. These two hinges allow for a revolving movement of the blade 3a around its own axis Xa. This axis shall coincide exactly with all the axes of any number of hinges used greater than two, if several connecting mechanisms or elements are in place. The distance of the own axis Xa of the blade 3a from the main revolving axis X of the turbine is known as radius R of the turbine 1. While the turbine 1 rotates, that is to say when the blades 3a, 3b, 3c turn around the main revolving axis X, the three blades 3a, 3b, 3c are moved individually following their axis Xa, Xb, Xc, controlled in the way which shall be described below. In the implementation form shown here, the blade 3a has a constant symmetric wing profile section throughout the length of the blade.— More specifically FIG. 6 shows the connecting edge 16a, the exit edge 18a, and the line 20a which connects the two edges 16a and 18a coincides with a direction Ya of the wing profile. The axis Ya of the blade 3a and the axis Za of the relevant support rod 4a form an angle Ha. The control pivot 72, which will be described below, placed at the maximum distance from the axis X of the turbine, makes sure that while the turbine 1 completes one round, the blades 3a, 3b and 3c take angular positions which are different from the relevant support rods, 4a, 4′a, 4b, 4′b, 4c, 4′c; thus the angular values Ha, Hb, Hc vary; more specifically they individually complete an alternative revolving movement, with a maximum width of about 60°, amounting to approximately 120° in total, as described in more detail below. In alternative implementation forms, the wing profile of the blade may take any other shape, for example asymmetric profiles in various sizes and proportions (flat, concave, convex, etc.). FIGS. 2 and 7, in the upper area of the rotor, show first of all two support elements 22, 24, (round plated), firmly distanced one from the other and firmly interconnected by means of three spacers 26 (pipes) of equal length. The lower element 24 (round plate), is firmly connected with the rotor 2.— Also the element 24 transmits to the rotor itself the revolving motion which it receives from the connection mechanisms 4′a, 4′b, 4′c of the blades, 3a, 3b, 3c, then transmits, because of the spacers 26, the revolving motion from the upper element 22 (round plate) to which the other connection mechanisms 4a, 4b, 4c are fixed, supporting the three blades 3a, 3b, 3c. FIG. 6 shows another advantageous element in this invention, namely that the different angular positions of the blades 3a, 3b, 3c, in respect of the relevant support rods 4a, 4′a, 4b, 4′b, 4c, 4′c, are obtained by means of appropriate auxiliary control mechanisms 60a, 60b, 60c, connected to the blades. The control mechanisms 60a, connected to the blade 3a, include a control element 62a, which shall have a predefined length, whose first end 64a is connected through a hinge to the control arm 63a, whose length shall be also predefined, joined to the blade 3a, and a second end 66a connected, through a hinge, to the connection rod of the piloting device 70, which is placed in axis with the rotor 2 exactly between the two elements 22 and 24 (round plates).— See FIGS. 11 to 14. In this implementation form, the piloting unit 70 is in the middle of the turbine in axis with the latter, but it could also be elsewhere (at the top or on the bottom), but always in axis with the turbine rotor. The piloting device 70 is placed between the two round plates 22 and 24 mentioned above.— The piloting device 70 includes first of all vertical control pivot 72, which needs to be long enough to include the hinges of as many first connection rods as the number of blades in the turbine; its axis Xp runs parallel to the main rotation axis X in rotor 2.— The control pivot 72 is able to move in a straight horizontal direction, for a specific length E. The different positions of the control pivot 72 in respect of the main revolving axis X are obtained by means of a motor-driven positioning device 100, which will be described below.—

FIG. 7 shows that the piloting device 70, associated with the blade 3a, is also expected to include a first connecting element 74a which shall link the control pivot 72 to the second end 66a of the control element 62a.—

The piloting device 70, associated with blade 3a, also includes a second connecting element 84a, with one first end 85a, hinged onto a pivot fixed along the axis Za to the connecting mechanism 4a of the blade 3a, on point 92a at a distance from the axis X which is equal to half the length of the first connecting element 74a.— The other end of the second connecting element 84a, is connected through a hinge on intermediate point 87a (centreline) of the first connecting element 74a.—

When constructing the piloting device 70, for its correct operation, in order to ensure the best incidence angle of the blades with regard to the wind direction during their circular rotation path around the axis main X of the turbine, it is necessary to use the following proportions between the connection, linkage and control elements.— See FIGS. 6 and 7.—

With the following turbine data being certain:
the distance from the rotation axis X of the turbine to the rotating axis Xa of the blade is equal to the radius R.—
the distance from the rotation axis X of the turbine to point 92a on the axis Xa is equal to the “module” M.—
the length of the first connecting element 74a in the piloting device is twice the length of M.—
the length of the second connecting element 84a in the piloting device is equal to the length of M.—
the distance which goes from axis X to the most distant point which can be reached from the control pivot 72 is known as “eccentricity” E; it can have any design value, however it should always be lower than the length of the module reduced by half of the sum of the technical overall size of the hinges within the first and second connecting element, respectively at the level of the pivot 92a and of the control pivot 72.—
the length of the control arm 63a is equal to the distance which goes from the rotation axis Xa of the blade 3a to the axis of the hinge on point 64a in the middle of the connection 62a. it is proportional to the length of the module M and to that of the eccentricity E.—
   specifically 63a=(√(3M²−2ME−E²)+M√3)/2.—
the length of the connecting mechanism 62a is proportional to the length of the radius R, to that of the module M and to that of the eccentricity E.— More specifically: 62a=√{(R−M)²+[(y−x)/2]²} where the value of y=m√3 and the value of x=√[4M²−(M+E)²].—

In the implementation form shown here, in FIG. 6 and the enlarged detail in FIG. 7, the control pivot 72 with the axis Xp is placed at the maximum distance from the axis X of the turbine, which means that it has the greatest eccentricity in respect of the axis X of the turbine.—

This position is calculated taking into account a condition of weak speed.—

Also in FIGS. 6 and 7 the overall orientation in respect of the wind direction at any given moment is positioned as if the wind were blowing from the top down, as indicated in the two figures by the acronym DV.—

The static configuration of FIG. 6 shows that in the mechanical piloting device 70 and the control mechanisms 62a, 62b, 62c, 63a, 63b, 63c, the respective blades 3a, 3b, 3c, are placed in angular positions Ha, Hb, Hc, in respect of the connecting mechanisms (support rods) 4a, 4′a, 4b, 4′b, 4c, 4′c. More specifically, it can be noted from FIG. 6 that the first blade 3a forms the angle Ha=90° in respect of the first support rod 4a, the second blade 3b forms the angle Hb=30° in respect of the second support rod 4b and the third blade 3c forms the angle Hc=150° in respect of the third support rod 4c.— All three blades have correct wind exposure with incidence from the wing profile entry side.—

It is possible to compare FIG. 8 with FIG. 10.— Both show the three blades in similar angular positions with regard to the rotor. The first shows the static position of the three moving blades with maximum eccentricity of the control pivot 72, as in FIGS. 6 and 7; in the second the eccentricity value is zero. The latter position would be the same which a turbine with fixed blades of the Darrieus type would have.—

It should be noted that the wind hits both wings on the left side with the correct entry incidence angle equal to zero, causing the same weak resistance of the blade to the wind, and an equally as weak negative torque of the rotor.— as regards the other two blades in the two drawings mentioned above, it should be noted that, in FIG. 8 where the turbine with moving blades has the maximum eccentricity, the wind hits correctly the two entry sides of the two blades, while in the FIG. 10—which shows a turbine corresponding to the one with fixed blades—the wind hits the blades from the exit side.— Without considering the different incidence angles, it is possible to conclude that, from an aerodynamic perspective, FIG. 10 is not correct because the blade position in respect of the wind direction does not allow for the best possible use of the wind thrust. This explains why the turbine referred to in the invention as shown in FIGS. 8 and 9, starts to rotate with a smaller wind speed.— It independently breaks its inertia with low wind speed, unlike what happens for example in the turbines with fixed blades, FIG. 10.— This is the reason why the turbine, with correctly oriented moving blades, is able to rotate with less wind speed.— It is more efficient that the turbine with fixed blades.—

In the static configurations of the four drawings shown in FIG. 16 the control pivot 72 and the correct overall orientation system to wind direction in that moment, are positioned as mentioned above, that is to say with maximum eccentricity and wind coming from the top of the image.—

Also in FIG. 16, the drawing on the left should be considered the starting point in respect of the subsequent three drawings which show the angular static positions of the three blades at each angular rotation in a clockwise direction of the turbine rotor by 30° each in respect of the previous position.— FIG. 17 shows the four drawings in FIG. 16 overlapping, where it is worth noting the position of the three blades every 30° within 360°.—

The sequence shows how the incidence angle of each blade 3a, 3b, 3c changes in respect of the wind direction DV.—

The variation of the angles Ha, Hb, Hc, while the turbine is revolving allows for efficient positioning of each blade 3a, 3b, 3c, in respect of the wind direction DV, thus transforming the wind thrust into rotor torque.—

By the same token, in drawings no. 18 and 19, with the length of the eccentricity E halved without the control pivot by the turbine axis, it is possible to notice the variations in the angles Ha, Hb, Hc.— It should also be noted that the performance of the turbine is reduced compared to the sequence in FIGS. 16 and 17 because the blades are hit by the wind with a smaller incidence angle.— the control unit with which the turbine with moving blades referred to in this is invention is fitted, in order to suitably adjust the speed of the rotor and—as a consequence—the generator speed in the optimal way to produce electricity, according to the variability of the wind speed, modifies the eccentricity E in order to reduce or increase the turbine performance.—

For most of the 360° rotation degrees in a full round of the turbine, the wind hits advantageously the entry sides 16a, 16b, and 16c on the wing profiles of the blades.— With the maximum eccentricity value E, it has been possible to speed to the maximum the partial rotation manoeuvre (about 120°) of the blades around themselves to avoid exposing the wrong side to the wind.— The said manoeuvre takes place only once every 360°.—

This is expected to result in an increase as regards turbine performance compared to existing models.— Such performance increase is achieved by managing, as described above, the angular position of the blades 3a, 3b, 3c, in respect of the wind direction DV to make sure that the latter, as they revolve around the main axis X, are hit by the wind from the best possible incidence angle according to aerodynamic laws, which in turn causes a greater torsion strength on the rotor.—

The motor-driven positioning device 100 on the control pivot 72, as shown in FIGS. 4 and 5, actually consists of the vertical control pivot 72 which is firmly fixed to a horizontal flat profile 126; the latter is assembled on two skids 104 and 105 with ball recirculation and two horizontal linear runners 106 and 108; as a consequence it can only move in a horizontal direction and the movement length is equal to the one in the calculation mentioned above.—

It is important and essential that the beginning of the movement possibility for the control pivot 72 (start of the stroke) should correspond to the intersection of the cart movement horizontal axis with the vertical axis X of the turbine.—

In other words, the axis Xp needs to coincide with the axis X.—

The two runners 106 and 108 and the two skids 104 and 105 may also be replaced by two calibrated round profiles and two sliding sleeves, also ball recirculating or by two mutually sliding elements which shall be connected through a dovetail joint or by means of a similar system.—

The cart 126 is fixed using the female screw 102 inside which the threaded bar 118 revolves which is connected through the joint 116 to the shaft 114 of the electric motor 112 which is fixed onto the horizontal support 110 onto which also the two aforesaid linear runners 106 and 108, to slide the cart 126.—

Therefore the clockwise or anticlockwise revolving movement of the shaft 114, of the electric motor 112 changes the horizontal position of the vertical control pivot 72 with the relevant axis Xp.—

The horizontal movement of the control pivot 72 is designed as a function of the wind speed at that movement measured by the control unit (not displayed) through the sensor (anemometer) placed on the outside close to the turbine, and a function of other parameters which the control unit needs to take into account and manage at the same time.—

It is certain that the distance of the control pivot 72 from the axis X is inversely proportional to the wind speed.— The maximum performance of the turbine is achieved when the eccentricity E of the control pivot 72 is at its maximum compared to the turbine axis.—

Should the control unit detect that the wind speed is excessive compared to the amount of energy required by the use system, it reduces the performance of the turbine by decreasing the eccentricity value E all the way to zero.—

In this situation the piloting unit, by means of the connecting and control elements, during the rotation of the turbine, causes the angular positioning of all blades in respect of the connecting mechanisms of elements, which is the same between each of them, by 90°, as shown in FIG. 10.— The turbine system is thus practically changed to a Darrieus version with fixed blades.—

In order to achieve maximum performance from the turbine, the overall mechanism 100 to adjust the eccentricity value on the control pivot 72 in respect of the position along the axis X of the turbine, which is responsible for the continuous angular adjustment of the blades according to their axis while the turbine is in operation, needs to be promptly oriented following the wind direction at that moment, on the level of the maximum distance of the control pivot 72 from the axis X of the turbine.—

This direction is produced by the motor 130 which is installed vertically in axis with the turbine axis within the fixed support 6 of the turbine.— See FIGS. 4-5-15.—

The motor 130 is fixed on the permanent section 6 of the turbine support; it is fitted with a reducer 132, which is assembled axially. The shaft coming out of the reducer, with a mechanical joint 133, is connected to a cylindrical element 120, self-centred by two bearings 122 and 124 assembled on the inside of the support 6 of the turbine.—

The self-centring unit 120 is firmly connected with the horizontal support 110 to which the whole motor-driven positioning device 100 is linked for placing of the control pivot 72.— The electric motor 130 is thus connected to the motor-driven device 100.— The axis of the electric motor 130 coincides with the turbine axis X and with the axis of the piloting unit, i.e. with the axis running through the starting point of the control pivot stroke 72.—

The control unit, through a sensor (weathervane), which is not shown, installed on the outside close to the turbine, cyclically, after a set length of time, shall measure the angular value of the wind direction at that moment, then average this value with the previous one and check the difference with the angle at which the overall positioning mechanism 100 of the shaft 72 is placed at that moment; after suitable calculations it shall activate the motor shaft 130 in a clockwise or anticlockwise direction to change or not the angle in use of the overall orientation mechanisms, based on the result of the said calculation.—

The control unit, while the turbine is in operation, shall always keep under control all of the speed values, as well as the wind direction at the moment, using the two external sensors (anemometer and weathervane); it needs to calculate instantaneously the rotor speed of the turbine, the temperatures in the motor and generator for the purpose of avoiding any overheating.— The control unit needs to be planned according to the various possible situations to make the prompt suitable adjustments for optimal performance of the turbine.—The control unit is able to manage power generation at all times using the ideal number of rounds of the generator for its maximum productivity, depending on the energy made available by the wind speed at that moment and on the amount of energy required downstream of the turbine, for use or storage, by adjusting the number of turbine rounds, enabling the horizontal motor (112) in respect of the wind speed and the vertical motor (130) in respect of the wind direction.— The revolving speed of the turbine, and subsequently the number of rounds of the power generator, are managed by controlling the moving blades as required, thereby increasing or decreasing the turbine performance. In the extreme case that the wind speed should prove to be excessively high, the control unit to reduce the revolving speed of the turbine rotor, after having reset the eccentricity value of the control unit 72 by managing the motor 112, is also able to further reduce the number of rounds of the turbine rotor down to zero by managing the motor 130 through increasingly erroneous information about the angular values of the actual wind direction, up to a maximum of 90°, and at the same time by repositioning the control pivot 72 at its maximum extension point.—Once the 90° value of the erroneous angular communication of the wind direction to the piloting device is reached, the blades will be placed at symmetric angles in respect of the turbine axis and the actual wind direction, which means that the torque values of the rotor, which will have opposite signs, will eliminate one another and—as a consequence, no rotation movement of the rotor will be produced. The solution suggested in the aforesaid invention advantageously provides a user-friendly, easily manageable system to reduce the number of rounds of the turbine due to excessive wind speed and to gusts which could lead to harmful consequences as regards the turbine mechanism or electrical part (overheating, etc.). The turbine is still subject to a strong overturning force because the blades offer strong resistance to the wind, but its rotation value is zero. Moreover, turbine 1 is equipped with an emergency braking unit 140 consisting of a disc brake applied to the rotor 2.— This braking unit is operated directly by the centrifugal force of the rotor 2 and it is designed to start working as soon as a specific speed of the said rotor 2 is exceeded.— This situation is likely to occur if there is no power being supplied to the control unit or if the energy produced is suddenly no longer used, that is to say when the turbine “runs off”.— A typical example of this is a flash of lightning which disconnects the public grid to which the turbine is connected and by which it is powered. The details of the braking unit 140 are not included here because they fall outside the scope of this invention and are already known in the industry. It has been proved, therefore, that this invention makes it possible to achieve the expected results. More specifically, the vertical axis wind turbine with moving blades referred to in this invention, has a better performance with the same wind speed, blade surface, and surface area affected by the movement of the latter (swept surface), compared to other known turbine models. The productivity of this turbine is higher because it breaks its inertia with lower wind speeds which guarantees operation with limited energy production but for much longer periods of time compared to other models, which—if the wind speed is limited—cause downtimes. This wind turbine, as the eccentricity value E varies, through the horizontal electric motor 112, inversely proportional to the wind speed, and managing in the correct way or not the overall mechanism 100 of the piloting unit 70 with the electric motor 130, depending on the wind direction at that moment, is able to manage the revolving speed of the turbine to produce power with the optimal number of rounds in the generator. In the event of a strong wind blowing, or of violent gusts of wind, the piloting device is able to reduce the revolving speed of the turbine until it stops by placing the blades with angular values symmetric in respect of the turbine axis according to the wind direction at that moment. This invention has been described with regard to the specific implementation form shown in the illustrations; it should be noted, however, that this invention is not limited to the specific implementation form presented and described herein. On the contrary, further variations of the implementation form described here are part of the purpose of this invention, as detailed in the relevant claims.

1. A vertical axis wind turbine with moving blades including a rotor which follows a vertical direction along one main revolving axis, three or more blades, all the same, directed vertically, placed peripherally in respect of the said rotor, equidistant one from the other and from the axis, parallel to the said axis, with each blade following a linear vertical direction with constant wing profile, and its own respective vertical rotation axis; each blade is connected to the said rotor through first connecting mechanisms, one or more for each blade, for the purpose of allowing said blade to rotate around its said main revolving axis, including also second connecting mechanisms in the same amount as the first, introduced between said blades and said first connecting mechanisms, for the purpose of allowing said blade to rotate around its said own respective vertical rotation axis so that it can be placed in different angular positions with regard to said first connecting mechanisms, while the said blade revolves around said rotor, said angular positions being obtained by means of auxiliary control mechanisms associated with said blade which include one control element where the first end is connected to a control arm, which is firmly fixed onto said blade, and a second end is connected to a piloting device associated with the center of said rotor wherein said piloting device single and in common between all blades, includes: one single control pivot which follows a piloting axis, vertical and parallel to said main rotation axis, several first connecting mechanisms, of specified length, for the purpose of connecting said control pivot to said second ends on said control elements, and several second connecting elements whose first ends are joined in specific points to said rotor and said second ends are joined in a middle point of said first connecting elements and that said first connecting elements are twice as long as said second connecting elements.

2. The turbine according to claim wherein a distance of the point where the first end of the second connecting element is joined to the said rotor by the turbine axis appears to be equal to the length of the second connecting element.

3. The turbine according to claim 1 wherein an orientation, according to wind direction at that moment, of a motor-driven positioning device on the control pivot, without changing any of the eccentricity values of the pivot itself, is possible when an electric motor, enabled for this purpose, is assembled vertically inside a fixed support of the turbine with its axis coinciding with the axis X of the turbine, the latter axis crossing a start of a stroke of a horizontal rectilinear movement of the control pivot.

4. The turbine according to claim 1 wherein a correct variation of eccentricity of the control pivot and its orientation—correct or not—in respect of a wind direction at that moment, within available wind speed limits, allow for an adjustment of turbine rounds based on maximum performance levels of a power generator.

5. The turbine according to claim 1 wherein in an event of a wind speed being excessive with or without gusts, and of any subsequent excess speed of the turbine due to malfunctioning of any kind, a control unit shall report to a vertical electric motor angular rotation values increased by as much as 90° compared to actual ones of the wind speed, and thus slow down to a point of stopping the turbine movement because, during its rotation, the blades, through lines of wing profiles, are gradually positioned symmetrically in respect of the turbine axis following an actual wind direction and, resetting a resulting torque of the rotor, are able to ensure mechanical integrity of the wind turbine.

6. The turbine according to claim 1 wherein a complex movement system of the blades is correct when a variation in the position of the control pivot from zero eccentricity to maximum eccentricity does not lead to any angular variation in the blades with regard to their vertical axis, and to a relevant first connecting mechanisms, just in two positions at 180° one with the other, exactly when they find themselves with wing lines parallel to an actual direction of the wind and at the same time at 90° in respect of the first connecting mechanisms.

7. The turbine according to claim 1 further comprising in the turbine rotor of two parallel metal discs, appropriately spaced but firmly connected one to the other with a suitable number of peripheral spacers, makes it possible to obtain between them a necessary space for correct operation of all connecting and control elements in the piloting device; moreover it makes it possible to place pivots for hinge joints with the rotor on a lower side of a topmost disc and a space between the two parallel metal discs is calculated as a function of the number of blades in the turbine.

8. The turbine according to claim 1 wherein inside the piloting device in each blade there is some space reserved for free movement of its first and second connecting elements, during various revolving conditions of the turbine, corresponding to a horizontal cylindrical circular section of suitable thickness.

9. The turbine according to claim 1 wherein said first connecting mechanisms include one or more support rods whose first ends are joined by means of hinges with the second connecting mechanisms linked to the said blades and the second ends are firmly linked to said rotor.

10. The turbine according to claim 1, wherein said first end in the aforementioned control element is joined by means of a hinge to said blade at a specified distance from said own axis of said blade, through the control arm, and that said second end of the said control element, which has a specified length, is moved while said rotor revolves by said piloting device to which it is joined by means of a hinge.

11. The turbine according to claim 1 wherein an intersection of a horizontal cart axis onto which the control pivot is firmly fixed, with the turbine revolving axis coincides with a beginning of a single horizontal rectilinear movement of specific length which may be completed by the control pivot.

12. The turbine according to claim 7, wherein it is possible to adjust the distance between said control pivot and said main rotation axis by means of a motor-driven positioning device whose purpose is to control its length.

13. The turbine according to claim 8, wherein said distance of said control pivot in respect of said main revolving axis, is increased to the maximum value or reduced to zero according in a way which is inversely proportional to the wind speed measured by the control unit, at close intervals or in a continuing way, to improve or not the turbine performance.

14. The turbine according to claim 1 wherein said rotor is connected with a power generation unit coaxially to the turbine or laterally by means of belt transmission system, gears, or other mechanisms.

15. A vertical axis wind turbine comprising:
a rotor having a main revolving axis;
a plurality of blades positioned around and parallel to said rotor, each of said plurality of blades having a connecting edge and an exit edge;
a support rod coupled to each of said plurality of blades and said rotor, said support rod having a support rod first end coupled to one of said plurality of blades and a support rod second end attached to said rotor;
a control pivot positioned an eccentric length from the main revolving axis of said rotor;
a first connecting element, associated with each of said plurality of blades, said first connecting element having a first connecting element first end and first connecting element second end, the first connecting element first end connected to said control pivot;
a control element, associated with each of said plurality of blades, said control element having a control element first end and a control element second end, wherein the control element first end is connected to the first connecting element second end;
a control arm, fixed to each of said plurality of blades, said control arm having a control arm first end and a control arm second end, wherein the control arm first end is coupled to the control element second end and the control arm second end is coupled to the support rod first end;
a second connecting element, associated with each of said plurality of blades, said second connecting element having a second connecting element first end and a second connecting element second end, the second connecting element first end connected to said support rod at a module length from said main revolving axis of said rotor and the second connecting element second end connected to said first connecting element at a midpoint of said first connecting element; and
a positioning device coupled to said control pivot, wherein said positioning device moves said control pivot relative to the main revolving axis changing the eccentric length,
whereby each of said plurality of blades are efficiently positioned relative to wind direction and speed.
